(19) United States
(12) Patent Application Publication
(10) Pub. No.: US 2022/0391546 A1
(43) Pub. Date: Dec. 8, 2022

(54) SERVER APPARATUS, NON-TRANSITORY COMPUTER READABLE RECORDING MEDIUM, AND DISCRIMINATING METHOD

(71) Applicant: MISUMI Group Inc., Tokyo (JP)

(72) Inventors: Fumiko HASHIZUME, Tokyo (JP); Kohei HIROSE, Tokyo (JP); Issei WATANABE, Tokyo (JP)

(73) Assignee: MISUMI Group Inc., Tokyo (JP)

(21) Appl. No.: 17/338,166

(22) Filed: Jun. 3, 2021

(51) Int. Cl. G06F 30/10

(52) U.S. Cl. CPC G06F 30/10; G06F 2111/02

(57) ABSTRACT

A server device has a processor that is configured to determine which unit system in a plurality of unit systems is a reference unit system of model data of an article, wherein the processor is configured to: acquire a feature dimension value used for the determination based on the model data; and determine the reference unit system based on a result obtained when the feature dimension value is defined according to each of the plurality of unit systems.

### BACKGROUND OF THE INVENTION

### Field of the Invention

The present invention relates to a server device for determining a reference unit system of model data of an article, a computer-readable non-temporary recording medium in which a computer program for causing a processor to perform the above-mentioned determination, and a determination method for causing the processor to perform the above-mentioned determination.

### Description of the Related Art

WO2007/044007A discloses a units selection that allows a customer to select intended dimensional units.

### SUMMARY OF THE INVENTION

A server device according to one aspect of the present invention has a processor that is configured to determine which unit system in a plurality of unit systems is a reference unit system of model data of an article. The processor is configured to acquire a feature dimension value used for the determination based on the model data, and determine the reference unit system based on a result obtained when the feature dimension value is defined according to each of the plurality of unit systems.

A computer-readable non-temporary recording medium according to another aspect of the present invention stores a computer program that causes a processor to determine which unit system in a plurality of unit systems is a reference unit system of model data of an article. The computer program causes the processor to acquire a feature dimension value used for the determination based on the model data, and to determine the reference unit system based on a result obtained when the feature dimension value is defined according to each of the plurality of unit systems.

A determination method according to still another aspect of the present invention is a determination method for causing a processor to determine which unit system in a plurality of unit systems is a reference unit system of model data of an article. The determination method has causing the processor to acquire a feature dimension value used for the determination based on the model data, and determine the reference unit system based on a result obtained when the feature dimension value is defined according to each of the plurality of unit systems.

Further features of the present invention will become apparent from the following description of the embodiments illustrated by way of examples with reference to the accompanying drawings.

### BRIEF DESCRIPTION OF THE DRAWINGS

FIG. 1 is a schematic view showing an overall configuration of a support system.

FIG. 2 is schematic block diagram of the support system.

FIG. 3 is a schematic view showing a project list window.

FIG. 4 is a schematic view showing a project detail screen in millimeter.

FIG. 5 is a schematic view showing a project detail screen in inches.

FIG. 6 shows an example of a table corresponding to the International System of Units.

FIG. 7 shows an example of a table corresponding to a system of units according to the yard-pound system.

FIG. 8 shows a flowchart for a determination process.

### DETAILED DESCRIPTION OF THE INVENTION

Hereinafter, exemplary embodiments for carrying out the present invention will be described in detail with reference to the drawings. However, the dimensions, materials, shapes and relative positions of the components described in the following embodiments can be freely set and can be changed according to the configuration of an apparatus to which the present invention is applied or to various conditions. Unless otherwise specified, the scope of the present invention is not limited to the embodiments specifically described below.

There are a plurality of systems of units as systems of units, which include basic units defining sizes of articles. For example, an International System of Units which includes “millimeters” as a unit of length is known, and a System of Units which follows the yard-pound system and includes “inches” as a unit of length is known. In addition, there is a Japanese traditional system of units according to the Shaku-kan system which includes “sun” and “bu” as units of length. The International System of Units is mainly used in Japan, but the system of units that complies with the yard-pound system is mainly used in North America.

A user who prepares model data for an article may request provision of service from a supplier who is in a region where a different system of units is used compared to the region in which the user is located. In this case, when estimating or ordering, the user may set the reference unit system used in the model data, every time. For example, in a design system for creating model data, a user may change a reference unit system in a user setting screen or a menu screen before starting the design. On the other hand, if the reference unit system is determined by the system, the procedure for the user to change the reference unit each time can be omitted.

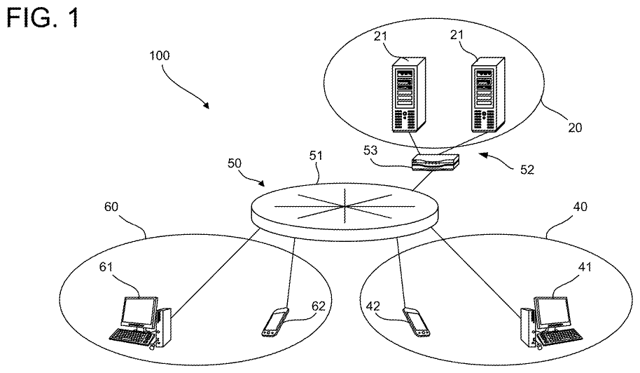

FIG. 1 shows an example of a support system 100 according to one embodiment of the present invention. In the support system 100, a server apparatus automatically determines the reference unit system of the model data (e.g., 3D CAD data) of an article uploaded by a user. Therefore, it is possible to prevent a situation in which the reference unit system is not changed due to a user's operation error. Also, the user can reliably check the dimensions of the model data before ordering the service. This prevents the user from ordering services based on the incorrect size of the article. In addition, the time and effort for the user to set the reference unit system in advance can be omitted.

The support system 100 will be described below with reference to FIG. 1. The support system 100 is configured as a network system or a client-server system. Incidentally, the support system 100 may be composed of a single server device. The support system 100 includes a support server 20 as an example of a server device. The support server 20 includes a processor (to be described later) configured to determine which unit system in a plurality of unit systems is a reference unit system of model data of the article.

The support system 100 also includes a user terminal 40 and a supplier terminal 60 as clients communicatively connected to the support server 20 via a network 50. Each of the user terminal 40 and the supplier terminal 60 is a computer device that can connect to the network. For example, the user terminal 40 may be one of a variety of devices that can connect to the network, such as a desk-top or stand-alone computer device 41, or a portable terminal 42 such as a smartphone. Similarly, the supplier terminal 60 may be a device such as a computer device 61 or a portable terminal 62.

The support server 20 is configured as a single logical server device, which is established upon combining a plurality of server units 21 as a plurality of computers. It should be noted, however, that the support server 20 may be configured by a single server unit 21. Alternatively, the support server 20 may be logically configured using cloud computing. The support server 20 may receive user identification information, which identifies the user, from the user terminal 40 and authenticate the user. The support server 20 may also receive supplier identification information, which identifies the supplier, from the supplier terminal 60 and authenticate the supplier.

Further, the support server 20 may store various data uploaded by the authenticated user or supplier. If the support server 20 stores such data, the support server 20 may send the stored data to the user terminal 40 and the supplier terminal 60. The support server 20 may also perform processing such as arrangements of services ordered by the user, delivery of products, and billing of charges for the provision of services. The support server 20 may collect fees from the user for the provision of services by the supplier. Additionally, support server 20 may collect fees for utilizing the support system 100 from a user or supplier.

The network 50 is configured to be able to connect the user terminal 40 and the supplier terminal 60 to the support server 20, respectively. In one example, the network 50 is configured to implement network communication using a TCP/IP protocol. Specifically, a LAN 52 connects the support server 20 and the Internet 51 with each other. The Internet 51 as a WAN, and the LAN 52 are connected to each other via a router 53. The user terminal 40 and the supplier terminal 60 are configured to be able to connect to the Internet 51. The network 50 may be any of a dedicated line, a telephone line, an intra-company network, a mobile communication network, other communication networks, and combinations thereof, whether wired or wireless. The server units 21 in the support server 20 may be interconnected by the Internet 51 in place of or in addition to the LAN 52.

The user terminal 40 and the supplier terminal 60 implement various computer software to allow the user and supplier to enjoy assistance by the support server 20. Each of the user terminal 40 and the supplier terminal 60 includes a display unit that is a display device such as a display or a touch panel, or is wired or wirelessly connected to the display unit. The user terminal 40 and the supplier terminal 60 may be various computer devices such as a notebook type personal computer or a portable tablet terminal device.

The support server 20 provides the supplier and the user with the various procedures necessary to establish a transaction between the supplier and the user through the user terminal 40 and the supplier terminal 60. In one example, the support server 20 is configured as a web server that displays various web pages on the user terminal 40 and the supplier terminal 60 in response to accesses from the user terminal 40 and the supplier terminal 60, respectively. The following description will deal with an example in which each of the user terminal 40 and the supplier terminal 60 displays a web page using a web browser.

### [Support Server]

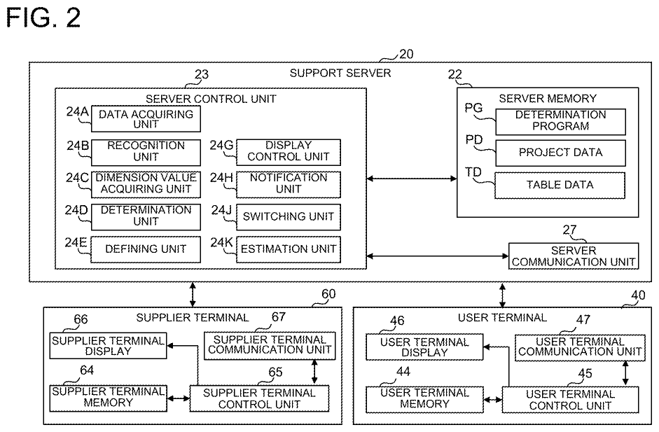

Referring to FIG. 2, the control system of the support server 20 will be described. The support server 20 includes a server control unit 23 for controlling the support server 20, and a server memory 22 which is an example of a storage unit to store a determination program PG. The server control unit 23 is configured as a computer that combines a processor, which executes various arithmetic processing and operation control according to a predetermined program, with other peripheral devices. The support server 20 includes a server communication unit 27 which is an example of a communication device for transmitting and receiving data to and from the user terminal 40 and the supplier terminal 60. The cloud type database may function as a storage unit.

In one example, the processor of the server control unit 23 is a CPU (Central Processing Unit) or an MPU (Micro-Processing Unit), and controls the entire support server 20 based on a program stored in the server memory 22 and also comprehensively controls various processes. The server memory 22 is a computer readable, non-temporary recording medium. The storage medium includes storage devices such as a RAM (Random Access Memory), which is a system work memory for the processor to operate, a ROM (Read Only Memory), an HDD (Hard Disc Drive), and an SSD (Solid State Drive) for storing programs and system software. The following description will deal with an example in which the processor executes various operations such as arithmetic operations, control, and determination in accordance with the determination program PG that is an example of a computer program stored in the ROM or the HDD. The determination program PG causes the processor of the server control unit 23 to perform the functions of the respective function units.

An interface for inputting (entering) a predetermined command and data including a keyboard or various switches is wired or wirelessly connected to the server control unit 23. Also, a monitor for displaying the input state, the setting state, the measurement result, and various information of the device is wired or wirelessly connected to the server control unit 23. The server control unit 23 may perform control in accordance with a program stored in a portable recording medium such as a CD (Compact Disc), a DVD (Digital Versatile Disc), a CF (Compact Flash) card, and a USB (Universal Serial Bus) memory, or an external storage medium such as a server on the Internet.

The server control unit 23 includes a data acquiring unit 24A which is an example of the data acquiring means, a recognition unit 24B which is an example of the element recognizing means, a dimension value acquiring unit 24C which is an example of the dimension value acquiring means, a determination unit 24D which is an example of the determination means, and a defining unit 24E which is an example of the definition means. Further, the server control unit 23 includes a display control unit 24G which is an example of the display control means, a notification unit 24H which is an example of the notifying means, a switching unit 24J which is an example of the switching means, and an estimation unit 24K which is an example of the estimation means.

The data acquiring unit 24A, the recognizing unit 24B, the dimension value acquiring unit 24C, the determining unit 24D, the defining unit 24E, the display control unit 24G, the notifying unit 24H, the switching unit 24J, and the estimation unit 24K function as the functional units, respectively, by the processor of the server control unit 23 executing the determination program PG. Each of the functional units is a logical device implemented by cooperation of computer hardware and software. Incidentally, at least a portion of the functional units may be provided on the user terminal 40 or the supplier terminal 60. Further, at least a portion of the functional units may be provided in an external computer device. In this case, the programs of the respective devices cooperate with each other to function as the determination program PG.

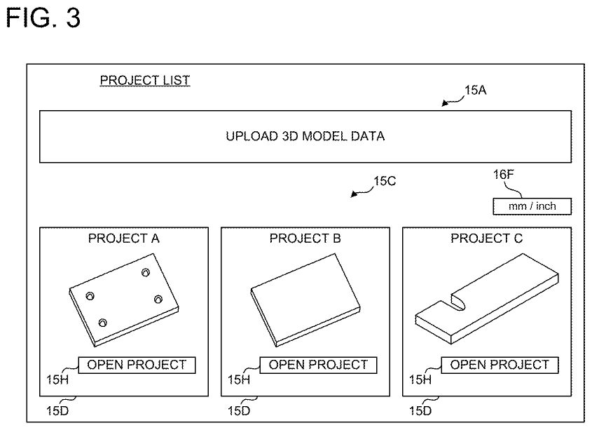

The display control unit 24G provides a web page to the user for uploading model data such as three-dimensional (3D) model data and two-dimensional (2D) model data. For example, the display control unit 24G provides a project list screen as shown in FIG. 3 to the user via the user terminal 40. The upload filed 15A for uploading the model data of the article is displayed in the project list screen. A sentence “Upload 3D model data” that prompts the user to upload data is displayed in the upload filed 15A. The user can upload desired model data by dragging and dropping operations, or by an operation specifying a file. As the user uploads the model data, a new project is created that contains the uploaded model data.

The existing project field 15C for displaying the projects that have already been created is displayed in the project list screen. In the existing project field 15C, a plurality of existing projects that constitute the past request history can be displayed, and the user can display a desired project on the project list screen by a scrolling operation or the like. The user may upload model data to the displayed existing project. In one example, upon uploading by the user, the server control unit 23 receives model data of an article consisting of a plurality of elements from the user terminal 40. The server control unit 23 stores the model data uploaded by the user in the server memory 22. The server memory 22 stores the model data in association with project identification information for identifying the project. For example, the server memory 22 stores the model data in the project data PD including the project identification information.

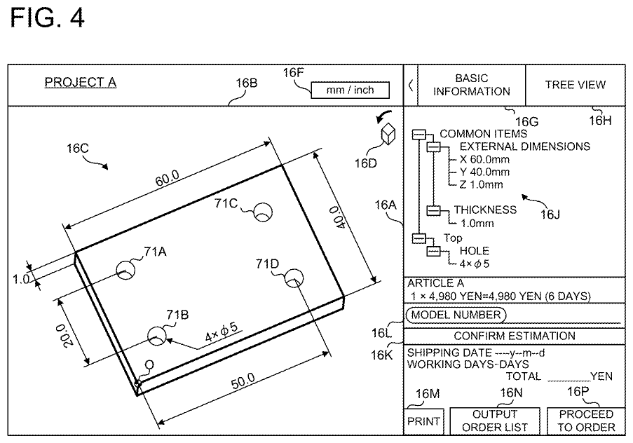

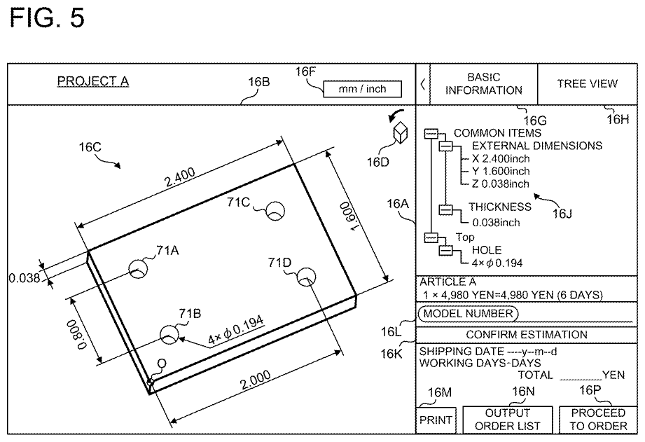

In addition, a thumbnail image 15D of the model data uploaded by the user is displayed in the existing project field 15C. A project icon 15H is provided for each of the projects in the existing project field 15C. When the user selects the project by specifying the project icon 15H, the project detail screen shown in FIG. 4 or FIG. 5 is displayed. That is, the display control unit 24G provides the user with the project detail screen through the user terminal 40.

### [Data Acquisition Means]

The data acquisition unit 24A acquires the model data of an article, which is uploaded by the user, from the server memory 22. For example, the article is a finished product in which the article itself has a particular set of functions, one part to be incorporated into a finished product, or an assembly composed of a plurality of parts. Furthermore, the article may be a unit in which a plurality of parts are assembled, a jig, a device or equipment. The model data is, for example, 3DCAD data and shows the shape of an article composed of a plurality of elements. For example, an element is a portion composing the article such as ridges, corners, surfaces, holes, shafts, steps, and cutouts, including features obtained by processing. The model data may also include information of the dimension and the location of each of the elements, and the like. The model data may be any data as long as the shapes of the elements of the article can be recognized from the model date. For example, the model data may be 2DCAD data, or data created in other forms. Alternatively, the data acquiring unit 24A may acquire the model data from an external device other than the support server 20.

### [Recognition Means]

The recognition unit 24B recognizes an element included in the article from model data acquired by the data acquisition unit 24A. In one example, the recognition unit 24B acquires a general shape pattern of an article corresponding to the model data from the server memory 22. For example, if the type of article is a pin, a general shape pattern indicates that in the axial direction of the pin, it has a flange part, a shank part, and a tip part in this order. The recognizing unit 24B recognizes and detects the shape of the element of the article indicated by the model data and the dimension of each element. The recognizing unit 24B stores the dimensional values of the respective elements associated with the respective elements in the server memory 22. In one example, the server memory 22 stores the dimensional values of each element defined by each of a plurality of unit systems (e.g., the International System of Units and the system of units according to the yard-pound system) such that the dimensional values are included in the model data. Alternatively, the recognition unit 24B may recognize the dimensional values of the respective elements based on the dimensional values included in the model data.

### [Dimension Value Acquiring Means]

The dimension value acquiring unit 24C acquires the feature dimension value used for determination of the reference unit system based on the model data. For example, the dimension value acquiring unit 24C acquires the feature dimension value from the dimension values corresponding to the elements recognized from the model data by the recognizing unit 24B. In one example, the feature dimension values include thickness of the components of the article such as plate thickness, diameter, radius, inner dimension, outer dimension, hole diameter, length, shaft length, radial direction length, tolerance, and pitch between elements. When the feature dimension value is the plate thickness, the dimension value acquiring unit 24C acquires, as the feature dimension value, a value indicating the plate thickness from the dimension values of the elements recognized by the recognizing unit 24B. Alternatively, the dimension value acquiring unit 24C may acquire the feature dimension value from the dimension values included in the model data.

### [Determining Means]

The determining unit 24D determines the reference unit system to be applied to the model data based on the results obtained when defining the feature dimension values according to each of a plurality of unit systems. For example, a reference unit system is either a system of units of length according to the yard-pound system and an international System of Units of length included in a plurality of unit systems. The International System of Units of length is a unit system whose base unit is meters, and includes units such as millimeters and centimeters. The unit system according to the yard-pound system is a unit system whose base unit is yards, and includes units such as inches and feet.

Further, when satisfying the first condition for defining the feature dimension values according to one unit system of the unit systems, the determination unit 24D determines that the reference unit system is the one unit system. Moreover, when satisfying the second condition for defining the feature dimension values according to another unit system different from the above-mentioned one unit system, the determination unit 24D determines that the reference unit system is the other unit system. Incidentally, the determination of whether to satisfy the first condition may be carried out before or after the determination of whether to satisfy the second condition.

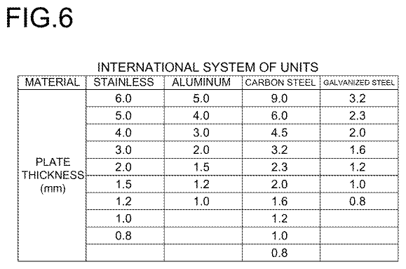

For example, the determination unit 24D refers to a table (hereinafter, occasionally referred to as a first table) that includes a plurality of feature dimension values defined by the one unit system. Then, the determination unit 24D determines that the first condition is satisfied when the feature dimension value defined by the one unit system is included in the first table. FIG. 6 shows a first table containing plate thicknesses as a plurality of feature dimensions defined by the International System of Units, which is an example of the one system unit. In the first table shown in FIG. 6, for a plate-like member which is a component of the article, the plate thickness for each material is included as a feature dimension value. Incidentally, the server memory 22 stores the first table included in the table data TD.

Specific materials included in the first table are stainless steel including SUS304 and SUS430 or the like, aluminum including Al—Mg based aluminum alloy (e.g., A5052) and the like, carbon steel including SPCC (cold-rolled steel sheet), SPHC (hot-rolled steel sheet), and a rolled steel sheet for general structures (e.g., SS400) and the like, and galvanized steel including SECC (electrogalvanized steel sheet) and SPCC (hot-dip galvanized steel sheet) and the like. The thickness is specified for each material, and in the case of stainless steel, a plurality of values ranging from 6.0 to 0.8 millimeters are included in the first table. The determination unit 24D refers to the first table shown in FIG. 6 when the dimension value acquiring unit 24C acquires the plate thickness of the plate-like member recognized by the recognition unit 24B. For example, when the plate thickness of the plate-like member is 1.0 millimeters, which is included in the first table, the determination unit 24D determines that the reference unit system to be applied to the model data is the International System of Units.

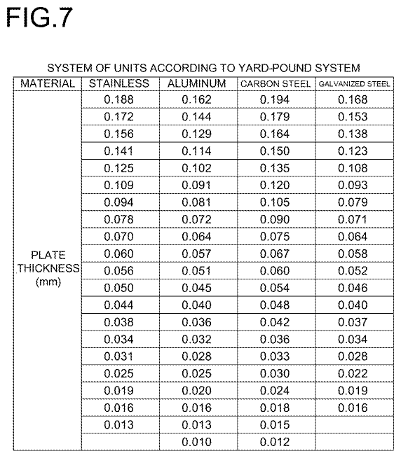

The determination unit 24D also refers to a table (hereinafter, occasionally referred to as a second table) including a plurality of feature dimension values defined by the other unit system, and determines that the second condition is satisfied when the feature dimensions defined by the other unit system are included in the second table. FIG. 7 shows the second table including plate thickness as a plurality of feature dimension values defined by a system of units according to the yard-pound system, which is an example of the other unit system. In the second table shown in FIG. 7, with respect to the plate-like member which is a component of the article, the plate thickness for each material is included as a feature dimension value. Incidentally, the server memory 22 stores the second table included in the table data TD.

Specific materials included in the second table are stainless, aluminum, carbon steel, and galvanized steel. Also, the plate thickness is specified for each material. In the case of stainless steel, a plurality of values in the range of 0.188 to 0.013 inches are included in the second table. The determination unit 24D refers to the second table shown in FIG. 7 when the dimension value acquiring unit 24C acquires the plate thickness of the plate-like member recognized by the recognition unit 24B. For example, if the plate thickness of the plate-like member is 0.038 inches, which is included in the second table, the determination unit 24D determines that the reference unit system to be applied to the model data is a system of units according to the yard-pound system.

Further, the determination unit 24D may determine the reference unit system to be applied to the model data based on the occurrence status of the fraction of the feature dimension value that occurs when defining values according to each of a plurality of unit systems. By way of example, the determination unit 24D calculates the ratio or number of the feature dimension values (e.g., the length of each element of an article), which are defined in accordance with the International System of Units, respectively including a fraction below the first fraction. In addition, the determination unit 24D calculates the ratio or number of the feature dimension values (e.g., the length of each element of an article), which are defined in accordance with a system of units according to the yard-pound system, respectively including a fraction below the third fraction. Then, the determination unit 24D determines that the unit system, in which the ratio or number of fractions included in the feature dimension values is smaller, is the reference unit system to be applied to the model data. In the model data created by the user, the dimensional values of each element are often set according to the reference unit system to be applied. Therefore, the unit system in which the ratio or number of fractions included is smaller is considered to be the reference unit system to be applied to the model data.

In one example, the plate thicknesses of the plate-like members included in an article are 1.2 mm, 1.0 mm, and 0.81 mm, and the plate thicknesses of the plate-like members contained in the same article are 0.013 inches, 0.016 inches, and 0.019 inches. In this case, the number of fractions below the first fraction of the plate thickness, which occurs when defined according to the International System of Units, is “1”. On the other hand, the number of fractions below the third fraction of the plate thickness, which occurs when defined according to the system of units according to the yard-pound system, is “0”. Therefore, the determining unit 24D determines that the system of units according to the yard-pound system, which has a smaller number of fractions, is the reference unit system to be applied to the model data.

Furthermore, the determination unit 24D may notify the user of the determination result via the user terminal 40. In one example, the determination unit 24D displays, as the determination result, an image or a character string (for example, a character of “millimeter” or “inch”) indicating the determined reference unit system on the user terminal 40. The user confirms the determination result and selects the switching button 16F shown in the project list screen (FIG. 3), if it is not the desired unit system. When the switching button 16F is selected, the switching unit 24J switches the dimensional display from one of the International System of Units and the system of units according to the yard-pound system to the other. Incidentally, when the switching is performed, the switching unit 24J may change the reference unit system defining the dimensional value of each element from one of the International System of Units and the system of units according to the yard-pound system to the other. In this instance, the defining unit 24E redefines the dimension value of each element according to the switched system of units (unit system of after switching).

### [Defining Means]

The defining unit 24E defines the dimensional values of the respective elements according to the reference unit system determined by the determining unit 24D. Specifically, the defining unit 24E defines the dimensional values of each element according to the reference unit system and stores them in the server memory 22 associated with each element. For example, it is assumed here that the determination unit 24D makes the determination using the feature dimensions, and determines the system of units according to the yard-pound system as the reference unit system to be applied to the model data. In this instance, the defining unit 24E defines the dimensional values of each element according to the system of units according to the yard-pound system when the recognizing part 24B has included the dimensional values of each element in the model data according to the International System of Units. Thus, the dimensional values of each element included in the model data are automatically defined according to the system of units according to the yard-pound system. Incidentally, the defining unit 24E defines the dimensional values of each element according to the International System of Units when the determining unit 24D determines that the International System of Units is the reference unit system to be applied to the model data.

### [Display Control Means]

The display control unit 24G displays a model represented by the model data. Further, the display control unit 24G applies to the model the dimensions represented by the reference unit system determined by the determination unit 24D and displays the dimensions together with the model. Furthermore, the display control unit 24G may apply to the model tolerances represented by the determined reference unit system and display the tolerances together with the model. Thus, the user can confirm the set reference unit system. For example, the project detail screen (FIG. 4, FIG. 5) displayed on the user terminal 40 by the display control unit 24G shows an article information filed 16A in which information about an article is indicated, and also shows a model display filed 16B. In the model display field 16B, 3D model 16C is displayed. The viewpoint for the 3D model 16C can be changed according to an operation by the user. In place of or in addition to the 3D model 16C, a 2D model such as a set of six surface views (front view, a rear view, a right side view, a left side view, a top view and a bottom view) may be displayed. In one example, the user may change the viewpoint of observing the 3D model 16C by specifying a viewpoint icon 16D of the model display field 16B. Alternatively, the viewpoint of observing the 3D model 16C may be changed by the operation of the user to move the 3D model 16C.

In FIG. 4, as the dimensions expressed by the reference unit system determined by the determining unit 24D, the dimensions expressed by the International System of Units are applied to the 3D model 16C. In one example, the display control unit 24G acquires and displays the dimensions of each element defined by the defining unit 24E. The dimensions of the respective elements are included in the model data and stored in the server memory 22. Specifically, as a dimension for each of holes 71A, 71B, 71C and 71D which are elements formed by machining, a hole diameter of 5 millimeters (φ5) is applied to the 3D model 16C. Further, 20.0 millimeters is applied as the dimension between the center of the hole 71A and the center of the hole 71B. Also, 50.0 millimeters is applied to the hole 71D, as the dimension on the long side with respect to the designed origin O. In addition, as the external dimensions of the article, a dimension of 60.0 millimeters in the Y direction, a dimension of 40.0 millimeters in the X direction, and a dimension of 1.0 millimeters in the Z direction are applied. Incidentally, units (e.g., “mm”) are not affixed to the dimensions displayed together with the 3D model 16C. Nevertheless, units may be affixed to the dimensions displayed along with the 3D model 16C.

In FIG. 5, as a dimension expressed by the reference unit system determined by the determination unit 24D, dimensions expressed by a system of units according to the yard-pound dimension are applied to the 3D model 16C. Specifically, a hole diameter of 0.194 inches (φ0.194) is applied to the 3D model 16C as a dimension of each of the holes 71A, 71B, 71C and 71D. Also, a value of 0.800 inches is applied as the dimension between the center of the hole 71A and the center of the hole 71B. Further, with respect to the hole 71D, a value of 2.000 inches is applied as the dimension on the long side with respect to the designed origin O. As the outer dimensions of the article, a dimension of 2.400 inches in the Y direction, a dimension of 1.600 inches in the X direction, and a dimension of 0.038 inches in the Z direction are applied. Incidentally, units (e.g., “inch” or “in”) are not affixed to the dimensions displayed together with the 3D model 16C. Nevertheless, units may be affixed to the dimensions displayed along with the 3D model 16C.

In FIG. 4 and FIG. 5, the article information filed 16A includes a basic information tab 16G and a tree view tab 16H. When the user selects the tree view tab 16H in the project detail screen, the tree view 16J as shown in FIG. 4 and FIG. 5 is displayed. In the basic information view (not shown) displayed by the user selecting the basic information tab 16G, for example, (user) order number, purchase quantity, material, content of the surface process, additional instructions (comments entered by the user), and the like are displayed as basic information of the article.

In the tree view 16J of FIG. 4, the dimension “60.0 mm” in the X direction, the dimension “40.0 mm” in the Y direction, and the dimension “1.0 mm” in the Z direction are displayed as information indicating the external dimensions of the article. Also, “4×φ5” is displayed as information indicating that the hole having the hole diameter “φ5” is machined in four places on the top surface of the article. In addition, on the tree view 16J of FIG. 5, the dimension “2.400 inch” in the X direction, the dimension “1.600 inch” in the Y direction, and the dimension “0.038 inch” in the Z direction are displayed as information indicating the external dimensions of the article. Also, “4×φ0.194” is displayed as information indicating that the hole having the hole diameter “φ0.194” is machined in four places on the top surface of the article.

In addition, “4980 yen” is displayed as the estimated cost of one article in the article information filed 16A of each of FIG. 4 and FIG. 5. In addition, “6 days” is displayed as the number of working days required before shipment. In FIG. 4 and FIG. 5, the confirmation button 16K of the estimate is displayed below the tree view 16J. As the user selects the confirmation button 16K, the total amount, the shipping date and the number of working days required before shipment are displayed below the confirmation button 16K. At this time, the amount obtained by multiplying the cost of the article estimated by the estimation unit 24K by the purchase quantity is displayed as the total amount. In addition, the model number corresponding to the displayed article is displayed in the model number field 16L. Further, a print button 16M is displayed below the confirmation button 16K. As the user selects the print button 16M, the estimated result is printed. In addition, the output button 16N of the order list and the order button 16P are displayed next to the print button 16M. In the order button 16P, the characters “Go to order” is displayed.

As the user selects the output button 16N, the user can output electronic data of the order list of the article. As the user selects the order button 16P, an order screen (not shown) for making an order is displayed on the user terminal 40. The user can order an article, which is specified by the model number, on the order screen. When the user orders the article, the server control unit 23 transmits the identified model number and the purchased quantity to the supplier. Further, the server control unit 23 may execute a process of sending an article delivery instruction to the supplier and a process of billing the user for the purchase price. Alternatively, if the user selects the order button 16P, the server control unit 23 may transmit the identified model number and the purchased quantity to the supplier of the article without displaying further operation screens.

When the user orders an article, the server control unit 23 transmits model data whose dimensions are defined in the reference unit system to another device separate from the support server 20. Specifically, the above-mentioned another device is the supplier terminal 60. Thus, it is possible to provide the supplier with the model data in which the dimensions are defined with the reference unit system determined by the determination unit 24D. Therefore, it is possible to prevent the model data in which dimensions are defined in the incorrect system of units from being transmitted to the supplier, or the model data in which dimensions are defined in the unknown system of units from being transmitted to the supplier. Alternatively, another device to which the model data is transmitted may be another server device that is separate from the support server 20.

### [Notifying Means]

The notifying unit 24H notifies the user of a fact that it does not conform when the determination unit 24D cannot determine the reference unit system. In one example, the notifying unit 24H causes the user terminal display 46 of the user terminal 40 to display sentences or images indicating that it does not conform. Alternatively, the notifying unit 24H may notify the user by causing a speaker included in the user terminal 40 to output a voice or a sound, or by causing a lamp included in the user terminal 40 to light or flash.

### [Switching Means]

The switching unit 24J accepts a switching instruction of the dimensional display from the user. Specifically, when the user wishes to switch the dimensional display, the user transmits the switching instruction of the dimensional display to the support server 20 by selecting the switching button 16F shown in each of FIG. 3, FIG. 4, and FIG. 5. In response to the switching instruction, the switching unit 24J switches between the first dimension display form in which a dimension represented by the reference unit system is applied to the model and displayed, and a second dimension display form in which a dimension represented by another unit system, which is different from the reference unit system, is applied to the model and displayed. For example, when the reference unit system is an International System of Units, the first dimension display form is displayed, as shown in FIG. 4, in which the dimensions expressed in the International System of Units are applied to the 3D model 16C. Upon receiving the switching instruction, the switching unit 24J displays the second dimension display form in which the dimensions expressed by the unit system according to the yard-pound system, as shown in FIG. 5, are applied to the 3D model 16C and displayed.

On the other hand, if the reference unit system is a system of units according to the yard-pound system, a second dimension display form is displayed, as shown in FIG. 5, in which the dimensions expressed in terms of a system of units according to the yard-pound system are applied to the 3D model 16C and displayed. Upon receiving the switching instruction, the switching unit 24J displays the first dimension display form in which the dimensions expressed by the International System of Units are applied to the 3D model 16C as shown in FIG. 4 and displayed. The dimensions to be displayed by switching may dimensions which are obtained as the switching unit 24J performs the calculation each time, using a predetermined conversion condition (e.g., 1 inch=25.4 mm). Alternatively, the defining unit 24E may calculate, in advance, dimensions represented by the respective unit systems to include them in the model data, and the switching unit 24J may use such dimensions. Incidentally, when the fraction is included in the dimension after conversion, the dimension obtained by rounding off or truncating the fraction may be used.

When the switching has been performed, the switching section 24J may change the reference unit system defining the dimensional value of each element from one of the International System of Units and the system of units according to the yard-pound system to the other. In this instance, the defining unit 24E redefines the dimensional value of each element according to the switched unit system (unit system after switching). Further, the switching unit 24J is able to make re-switching from the second dimension display form to the first dimension display form, and from the first dimension display form to the second dimension display form. The switching instruction of the dimensional display entered by the user is not limited to the selection of the switching button 16F. For example, the switching instruction may be an instruction using the voice input function of the user terminal 40 or an instruction by a predetermined operation such as moving the pointer to the tree view 16J. The applying of dimensions to the 3D model 16C may be made by, in addition to displaying the dimensions together with the dimension lines, displaying the dimensions side by side the 3D model 16C or displaying the dimensions overlaid on the 3D model 16C.

In response to the switching instruction of the dimensional display by the user, the switching unit 24J may switch between the first dimension display form or the second dimension display form, and a third dimension display form in which the dimensions represented by the reference unit system and the dimensions represented by another unit system are both applied to the model and displayed. The third dimensional display form is a form in which the dimensions expressed by a plurality of unit systems different from each other are displayed side by side. For example, “1.0” (mm), which is the dimension according to the reference unit system, and “0.039” (inch), which is the dimension according to the other unit system, are displayed so as to be aligned vertically or horizontally. Here, it is desirable that the dimensions according to the reference unit system are displayed so as to be distinguishable from the dimensions according to other unit systems. For example, “1.0 [0.039]” is an exemplary display for distinguishing by parentheses. In addition, two types of dimensions may be distinguished from each other by differences in display aspects such as underline, font, size, color, density, or brightness.

Further, the switching unit 24J may switch between one of the first dimension display form and the second dimension display form, and the third dimension display form, or between the first dimension display form, the second dimension display form, and the third dimension display form. For example, when switching between the first dimension display form, the second dimension display form, and the third dimension display form, the switching unit 24J changes the first dimension display form, the second dimension display form, and the third dimension display form in this order, each time the user selects the switching button 16F.

Further, the switching of the dimensional display form, and the displaying of the switched dimensional display form may not be performed continuously. For example, when the user selects the switching button 16F on the project list screen of FIG. 3, the switching unit 24J receives the switching instruction of the dimensional display by the user. After that, when the user selects the project by specifying the project icon 15H, the project detail screen shown in FIG. 4 or FIG. 5 is displayed. The switching unit 24J displays the dimensions on the project detail screen according to the first dimension display form or the second dimension display form in accordance with the switching instruction.

### [Estimation Means]

The estimation unit 24K calculates the cost of the article based on the reference unit system determined by the determination unit 24D. For example, when the user selects the confirmation button 16K in the project detail screen, the estimation unit 24K calculates the cost of the article based on the determined reference unit system. Then, the estimation unit 24K displays the total amount obtained by multiplying the number of articles by the cost of the article, the shipping date, and the working days before shipment on the project detail screen. When the user confirms the displayed estimate results and selects the order button 16P on the project detail screen, the order screen is displayed on the user terminal 40. Then, the user can order an article on the order screen.

In one example, based on the type of the article entered by the user and the shape of the article that is recognized by the recognition unit 24B, the estimation unit 24K acquires the manufacturing conditions (for example, the material, the surface-treatment method, and the tolerance range, etc.), that can be selected, from the server memory 22. Furthermore, the estimation unit 24K acquires the manufacturing conditions entered or changed by the user. Then, the estimation unit 24K calculates the cost of the article, the shipping date, and the working days required before shipment for the pattern in which the article is combined with the manufacturing conditions. For example, the estimating unit 24K calculates the cost of the article and the like by referring to the data table stored in advance in the server memory 22.

Incidentally, if it has been switched to the second dimension display form in which the dimensions represented by another unit system is displayed, the estimation unit 24K may calculate the cost of the article based on the other unit system. In this case, the estimation unit 24K may calculate the cost of the article based on the other unit system and the cost of the article based on the reference unit system each time upon the switching made by the switching unit 24J. If it has been switched to the third dimension display form in which both the dimensions represented by the reference unit system and the dimensions represented by the other unit system are displayed, the estimation unit 24K may calculate the cost of the article based on the other unit system and the cost of the article based on the reference unit system. In this case, the estimation unit 24K displays the estimation results calculated using the two costs so as to be aligned vertically or horizontally. Here, it is desirable that the estimation result (e.g., the total amount) calculated by using the cost of the article based on the reference unit system is displayed so as to be distinguishable from the estimation result calculated using the cost of the article based on the other unit system. For example, two types of dimensions may be distinguished from each other by differences in display aspects such as parentheses, underline, font, size, color, density, or brightness.

The server control unit 23 transmits the model data whose dimensions are defined by the reference unit system determined by the determination unit 24D, together with the estimation result of the total amount and the like, to the supplier terminal 60 which is a device different from the support server 20. Incidentally, when the estimation unit 24K calculates the cost of the article based on the other unit system, the server control unit 23 may transmit the model data whose dimensions are defined by the other unit system to the supplier terminal 60 together with the estimation result of the total amount and the like.

### [User Terminal and Supplier Terminal]

The user terminal 40 includes a user terminal control unit 45 that controls the user terminal 40 and a user terminal memory 44 that is an example of a user terminal storage unit that stores a control program (not shown). The user terminal control unit 45 is configured as a computer in which a processor for executing various arithmetic processing and operation control according to a predetermined program is combined with other peripheral devices. The user terminal 40 includes a user terminal display 46 which is an example of a display unit for displaying a web page generated by the support server 20. For example, the user terminal 40 displays the web page using a web application provided by the support server 20 or a pre-installed client software.

Further, the user terminal 40 includes a user terminal communication unit 47 which is an example of a communication device for transmitting and receiving data to and from the support server 20. The user terminal 40 may directly transmit and receive data to and from the supplier terminal 60 by the user terminal communication unit 47. The user terminal 40 also includes an input unit (not shown) which is an example of an input device including a keyboard or various switches for entering commands, instructions and data. Incidentally, a display unit such as a touch panel may function as the input unit.

The supplier terminal 60 includes a supplier terminal control unit 65 that controls the supplier terminal 60 and a supplier terminal memory 64 that is an example of a supplier terminal storage unit that stores a control program (not shown). The supplier terminal control unit 65 is configured as a computer in which a processor for executing various arithmetic processing and operation control according to a predetermined program is combined with other peripheral devices. The supplier terminal 60 also includes a supplier terminal display 66 which is an example of a display unit for displaying a web page generated by the support server 20. For example, the supplier terminal 60 displays the web page using a web application provided by the support server 20 or pre-installed client software.

Further, the supplier terminal 60 includes a supplier terminal communication unit 67 which is an example of a communication device for transmitting and receiving data to and from the support server 20. The supplier terminal 60 may directly transmit and receive data to and from the user terminal 40 by the supplier terminal communication unit 67. The supplier terminal 60 also includes an input unit (not shown) which is an example of an input device including a keyboard or various switches for entering commands, instructions and data. Incidentally, a display unit such as a touch panel may function as the input unit.

The user terminal control unit 45 and the supplier terminal control unit 65 are similar to the server control unit 23 in that they are configured as a computer including a processor such as a CPU. Further, the user terminal memory 44 and the supplier terminal memory 64 are similar to the server memory 22 in that they are configured as computer-readable non-temporary recording media including a ROM, an HDD or the like. Therefore, a detailed description of the user terminal control unit 45, the supplier terminal control unit 65, and the user terminal memory 44 and the supplier terminal memory 64 will be omitted.

### [Determination Flow]

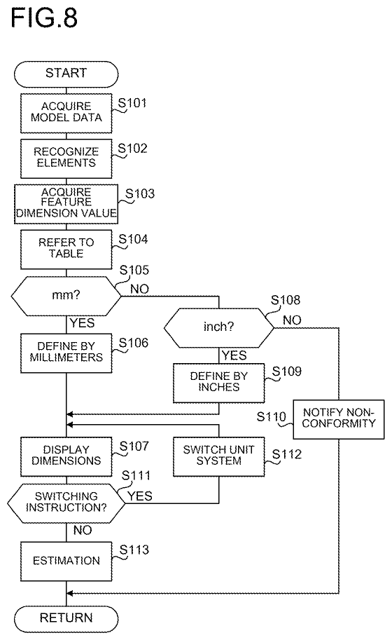

Referring to FIG. 8, an exemplary determination flowchart performed by the support server 20 will be described. When the user uploads the model data of the article, the data acquisition unit 24A acquires the uploaded model data (e.g., 3DCAD data) from the server memory 22 (S101). Further, the recognition unit 24B recognizes the elements included in the article from the model data acquired by the data acquisition unit 24A (S102). Then, the recognizing unit 24B detects the dimensional values of the respective elements from the model data and stores them in the server memory 22.

Subsequently, the dimension value acquiring unit 24C acquires the feature dimension value from among the dimension values detected by the recognizing unit 24B (S103). For example, the feature dimension value may be the plate thickness or length of a plate-like member of the article formed by sheet metal working, or the axial length or radial length of a cylindrical member of the article formed by cutting. Furthermore, the feature dimension value may be a pitch between each two adjacent screw holes, or a hole diameter of a prepared hole of the screw hole, or the like. The following description will deal with an example in which the feature dimension value is the plate thickness of the plate-like member.

The determining unit 24D determines the reference unit system to be applied to the model data. To this end, the determination unit 24D refers to the first table (FIG. 6) that includes a plurality of plate thicknesses defined by the International System of Units and the second table (FIG. 7) that includes a plurality of plate thicknesses defined by the unit system according to the yard-pound system (S104). When the plate thickness is included in the first table (YES in S105), the determining unit 24D determines that the reference unit systems to be applied to the model data is the International System of Units. Further, the determination unit 24D notifies the user of the determination result through the user terminal 40. For example, the determination unit 24D causes the user terminal 40 to display, together with the unit of “millimeters” as the determination result, a confirmation message for confirming whether or not the unit system may be changed to the unit system including the unit of “mm.” When the confirmation operation is made by the user, the defining unit 24E defines the dimensional values of the respective elements according to the International System of Units determined by the determination part 24D (S106). Then, the display control unit 24G applies the dimensions expressed by the International System of Units determined by the determination unit 24D to the 3D model 16C and displays them (S107).

If the plate thickness is not included in the first table (NO in 5105) and is included in the second table (YES in S108), the determination unit 24D determines that the reference unit system to be applied to the model data is a system of units according to the yard-pound system. Further, the determination unit 24D notifies the user of the determination result through the user terminal 40. For example, the determination unit 24D causes the user terminal 40 to display, together with the units of “inch” as the determination result, a confirmation message for confirming whether or not the unit may be changed to the unit system including such unit. When the confirmation operation is made by the user, the defining unit 24E defines the dimensional values of the respective elements according to the system of units according to the yard-pound system determined by the determining unit 24D (S109). Then, the display control unit 24G applies the dimensions expressed by the unit system according to the yard-pound system determined by the determination unit 24D to the 3D model 16C and displays them (S107).

If the plate thickness is not included in the first table (NO in S105) and is not included in the second table (NO in S108), the notifying unit 24H notifies the user that it does not conform to the predetermined systems of units (S110). Then, the determination flow in the support server 20 ends. In one example, the notifying unit 24H informs the user of the non-conformity in the project list screen. Incidentally, the reference to the first table may be performed prior to the reference to the second table, or vice versa.

As the user selects the switching button 16F, the switching unit 24J accepts a switching instruction of the dimensional display (YES in S111). Then, the switching unit 24J changes one of the first dimension display form and the second dimension display form to the other (S112). In the first dimension display form, the dimensions expressed by the International System of Units are applied to the 3D model 16C and displayed. In the second dimension display form, the dimensions expressed by the system of units according to the yard-pound system are applied to the 3D model 16C and displayed. Then, the display control unit 24G applies the dimensions represented by the unit system after switching made by the switching unit 24J to the 3D model 16C, and displays them (S107). If the dimension display is not changed (NO in S111) and the user selects the confirmation button 16K in the project detail screen, the estimation unit 24K performs an estimate based on the reference unit system determined by the determination unit 24D and calculates the cost of the article (S113).

When the user who has confirmed the estimated result selects the order button 16P, an order screen (not shown) for making the order is displayed on the user terminal 40. Then, the user orders the article specified by the model number on the order screen. Thus, the server control unit 23 transmits to the supplier terminal 60 the manufacturing data including the estimation result and the model data whose dimensions are defined by the reference unit system. Then, the determination flow in the support server 20 ends.

Alternatively, the estimation unit 24K may perform the estimation when the display control unit 24G applies the dimensions to the 3D model 16C and displays them. Alternatively, the estimation unit 24K may perform the estimation when the data acquisition unit 24A acquires the model data uploaded by the user. In this case, the estimation unit 24K may display the estimation result on the project list screen. Incidentally, the determination unit 24D may display the determination result together with the notification of the estimation result estimated by the estimation unit 24K. Further, the user may select a 2D drawing creation button (not shown) in the program detail screen. When the user selects the 2D drawing creation button, the server control unit 23 creates a 2D drawing such as a set of six surface views so that the dimensions defined in the model data by the reference unit system are reflected in the 2D drawing.

According to the support server 20 of the above-described embodiment, the reference unit system can be determined from the model data based on the feature dimension values. Therefore, the determination unit 24D only needs to refer to the feature dimension values from among a plurality of types of dimension values. Thus, it is possible to quickly determine the reference unit system. Moreover, by automatically changing the display according to the determination result, the user need not perform the task of changing the unit system to be applied to the model data. In addition, the correct reference unit system can be applied to the model data even if the task of changing the system of units to be applied to the model data is forgotten by human error.

While the present invention has been described with reference to the respective embodiments, the present invention is not limited to the above-described embodiments. Inventions modified to the extent that they are not contrary to the present invention, and inventions equivalent to the present invention are also included in the present invention. In addition, each of the embodiments and each modification can be appropriately combined within a range not contrary to the present invention.

For example, a value obtained by defining a feature dimension value by the International System of Units may be included in the first table, and a value obtained by defining the same feature dimension value by the system of units according to the yard-pound system may also be included in the second table. In one example, the first table may include a feature dimension value of 12.7 millimeters and the second table may include a feature dimension value of 0.500 inches. That is, a certain feature dimension value may belong to the International System of Units and the system of units according to the yard-pound system. In this case, the determination unit 24D refers to the estimation result estimated by the estimation unit 24K, and determines that a unit system that gives the user a more advantageous estimation result should be a reference unit system. For example, the determination unit 24D determines that a system of units in which the cost of the article becomes cheaper be a reference unit system.

Part or all of the above-described embodiments may also be described as in the following appendices, but not limited thereto.

### [Supplementary Note 1]

A support system for determining which unit system in a plurality of unit systems is a reference unit system of model data of an article, the support system comprising:

an acquiring unit acquiring a feature dimension value used for the determination based on the model data; and

a determination unit determining the reference unit system based on a result obtained when the feature dimension value is defined according to each of the plurality of unit systems.

What is claimed is:

1. A server device having a processor that is configured to determine which unit system in a plurality of unit systems is a reference unit system of model data of an article, the server device comprising the processor configured to:
acquire a feature dimension value used for the determination based on the model data; and
determine the reference unit system based on a result obtained when the feature dimension value is defined according to each of the plurality of unit systems.

2. The server device according to claim 1, wherein the processor is configured to:
recognize an element included in the article from model data and acquire the feature dimension value from dimension values corresponding to the elements;
determine, when satisfying a first condition for defining the feature dimension values according to one unit system of the plurality of unit systems, that the reference unit system is the one unit system; and
determine, when satisfying a second condition for defining the feature dimension values according to another unit system different from the one unit system, that the reference unit system is the other unit system.

3. The server device according to claim 2, wherein the processor is configured to:
refer to a table including a plurality of feature dimension values defined by the one unit system; and
determine, when the feature dimension value defined by the one unit system is included in the table, that the first condition is satisfied.

4. The server device according to claim 2, wherein the processor is configured to:
refer to a table including a plurality of feature dimension values defined by the other unit system; and
determine, when the feature dimension value defined by the other unit system is included in the table, that the second condition is satisfied.

5. The server device according to claim 1, wherein the processor is configured to determine the reference unit system based on occurrence status of fraction of the feature dimension value that occurs when defining the feature dimension value according to each of a plurality of unit systems.

6. The server device according to claim 1, wherein the processor is configured to notify non-conformity when the reference unit system is unable to be determined.

7. The server device according to claim 1, wherein the processor is configured to apply dimensions represented by the reference unit system to a model represented by the model data, and display the dimensions together with the model.

8. The server device according to claim 7, wherein the processor is configured to:
receive a switching instruction of a dimensional display from by a user; and
switch between a first dimension display form and a second dimension display form in response to the switching instruction, wherein dimensions represented by the reference unit system are applied to the model and displayed in the first dimension display form, and dimensions represented by another unit system different from the reference unit system are applied to the model and displayed in the second dimension display form.

9. The server device according to claim 7, wherein the processor is configured to:
receive a switching instruction of a dimensional display from by a user; and
switch between a first dimension display form or a second dimension display form, and a third dimension display form in response to the switching instruction, wherein dimensions represented by the reference unit system are applied to the model and displayed in the first dimension display form, dimensions represented by another unit system different from the reference unit system are applied to the model and displayed in the second dimension display form, and dimensions represented by the reference unit system and dimensions represented the other unit system are both applied to the model and displayed in the third dimension display form.

10. The server device according to claim 1, wherein the plurality of unit systems includes a system of units of length according to a yard-pound system and an international System of Units of length.

11. The server device according to claim 1, wherein the feature dimension value is thickness of a component of the article.

12. The server device according to claim 1, wherein the processor is configured to calculate a cost of the article based on the determined reference unit system.

13. The server device according to claim 1, wherein the processor is configured to transmit the model data in which dimensions are defined in the reference unit system to another device separate from the server device.

14. A computer-readable non-temporary recording medium storing a computer program that causes a processor to determine which unit system in a plurality of unit systems is a reference unit system of model data of an article, the computer program causing the processor to:
acquire a feature dimension value used for the determination based on the model data; and
determine the reference unit system based on a result obtained when the feature dimension value is defined according to each of the plurality of unit systems.

15. A determination method for causing a processor to determine which unit system in a plurality of unit systems is a reference unit system of model data of an article, the determination method comprising:
causing the processor to:
acquire a feature dimension value used for the determination based on the model data; and
determine the reference unit system based on a result obtained when the feature dimension value is defined according to each of the plurality of unit systems.
